(19) United States
(12) Patent Application Publication
(10) Pub. No.: US 2020/0249402 A1
(43) Pub. Date: Aug. 6, 2020

(54) PORT CLEANERS WITH CONTACT WIPERS

(71) Applicant: HEWLETT-PACKARD DEVELOPMENT COMPANY, L.P., SPRING, TX (US)

(72) Inventors: KATIA BENSON, FORT COLLINS, CO (US); HUI HE, FORT COLLINS, CO (US); RYAN P MOORE, FORT COLLINS, CO (US)

(21) Appl. No.: 16/638,206

(22) PCT Filed: Sep. 29, 2017
(86) PCT No.: PCT/US2017/054362

§ 371 Date: Feb. 11, 2020

(51) Int. Cl. G02B 6/38; B08B 1/00

(52) U.S. Cl. CPC G02B 6/3866; B08B 1/006

(57) ABSTRACT

In an example, a port cleaner may include a body having a fluid aperture extending into the body. The fluid aperture may extend into a surface of the body. The port cleaner may also include a fluid channel disposed, at least partially, within the body and may be in fluid communication with the fluid aperture. The port cleaner may further include a wiper or contact wiper engaged with the fluid channel and movable between a lowered position and a raised position. The contact wiper may extend from a surface of the body when disposed in the raised position.

### BACKGROUND

Electronic devices may include communication ports to receive connectors, cables, and other types of components for the transfer of data and/or power signals to or from the electronic device. Such communication ports may include electrical contacts or other signal transfer elements to engage with complementary contacts or elements disposed on a component engaged with the communication port. Engagement of the signal transfer elements within a communication port with complementary contacts or elements may enable such transfer of data and/or power signals.

### BRIEF DESCRIPTION OF THE DRAWINGS

FIG. 1A is a perspective view of an example port cleaner.

FIG. 1B is a perspective view of an example port cleaner.

FIG. 2 is a perspective view of an example port cleaner.

FIG. 3A is a perspective view of an example port cleaner.

FIG. 3B is a perspective view of an example port cleaner.

FIG. 4A is a perspective view of an example communication port having an example port cleaner.

FIG. 4B is a cross-sectional view of an example communication port having an example port cleaner.

FIG. 4C is a cross-sectional view of an example communication port having an example port cleaner.

### DETAILED DESCRIPTION

Electronic devices may communicate with other devices through the use of communication ports disposed on the electronic devices. Such communication ports may receive and engage with complementary plugs or connectors to enable such communication between devices. Specifically, communication ports may include electrical contacts or other signal transfer elements which may operably engage with complementary electrical contacts or signal transfer elements of a plug or connector engaged with the communication port to enable the transfer of data and/or power signals between the electronic device and another device.

In some situations, electronic devices, and thus communication ports disposed thereon, may be exposed to water, coffee, rain, sweat or other moisture, chemicals, and/or other contaminants. Such contaminants may cause corrosion or other detrimental effects on or within the communication ports, and signal transfer elements, e.g., electrical contacts, disposed therein. The accumulation of corrosion or other contaminants on the signal transfer elements may have a negative effect on the function of the communication port, and may inhibit the effective and efficient transfer of data and/or power signals through the communication port. Thus, it may be desirable to avoid the accumulation of such contaminants on the signal transfer elements of communication ports. In some situations however, exposure of the communication ports to such contaminants may be difficult to avoid, and thus it may further be desirable to clean or remove contaminants from the communication ports and the signal transfer elements disposed within them.

Traditional cleaning methods may include blowing compressed air into communication ports, or using cotton swabs or similar items to clean out and remove foreign particles and contaminants from communication ports. While possibly useful for extracting loose particles like dust or dirt from the communication port, these existing methods may not be effective at removing contaminants that have built up on or become attached to the signal transfer elements of the communication ports, or contaminants that result from a chemical reaction, such as corrosion. Further, in some situations, forcing foreign objects like cotton swabs, toothpicks, or the like into a communication port to clean it may actually result in damaging often-delicate components disposed within the communication port, thus resulting in the cleaning process negatively affecting the function of the communication port further. Therefore, it may be desirable in some situations to use a cleaning device that is designed and structured specifically for the type of port to be cleaned, thereby minimizing the possibility of damaging the communication port or components disposed within it. Further, it may also be desirable for such a cleaning device to press against or exert a pressure on signal transfer elements within the communication port to wipe away or clean contaminants that have built up on or become attached to them, and thereby effectively improving the function of the communication port.

Implementations of the present disclosure provide port cleaners with contact wipers to wipe and clean contaminants disposed on signal transfer elements, e.g., electrical contacts, of a communication port. Example port cleaners disclosed herein may be sized and structured so as to engage with a communication port in a safe manner, while engaging with the signal transfer elements within in order to effectively clean and improve performance of the communication port.

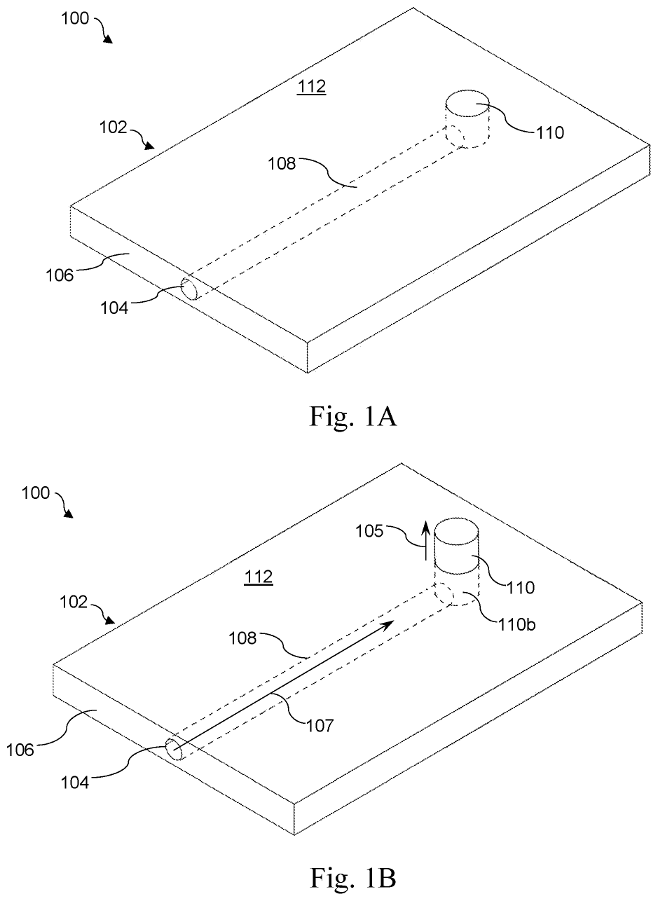

Referring now to FIG. 1A, a perspective view of an example port cleaner 100 is illustrated. The example port cleaner 100 may include a body 102 having a fluid aperture 104 extending into the body 102. In some implementations, the fluid aperture 104 may extend into a front surface 106 of the body 102, and, in other implementations, the fluid aperture 104 may extend into the body 102 from another surface or portion. The port cleaner 100 may also include a fluid channel 108 disposed, at least partially, within the body 102 and may be in fluid communication with the fluid aperture 104. The port cleaner 100 may further include a wiper or contact wiper 110 operably engaged with the fluid channel 108 and movable between a lowered position (illustrated in FIG. 1A) and a raised position (illustrated in FIG. 1B). The contact wiper 110 may extend from a surface, which may be a top surface 112 in some implementations, of the body 102 when disposed in the raised position.

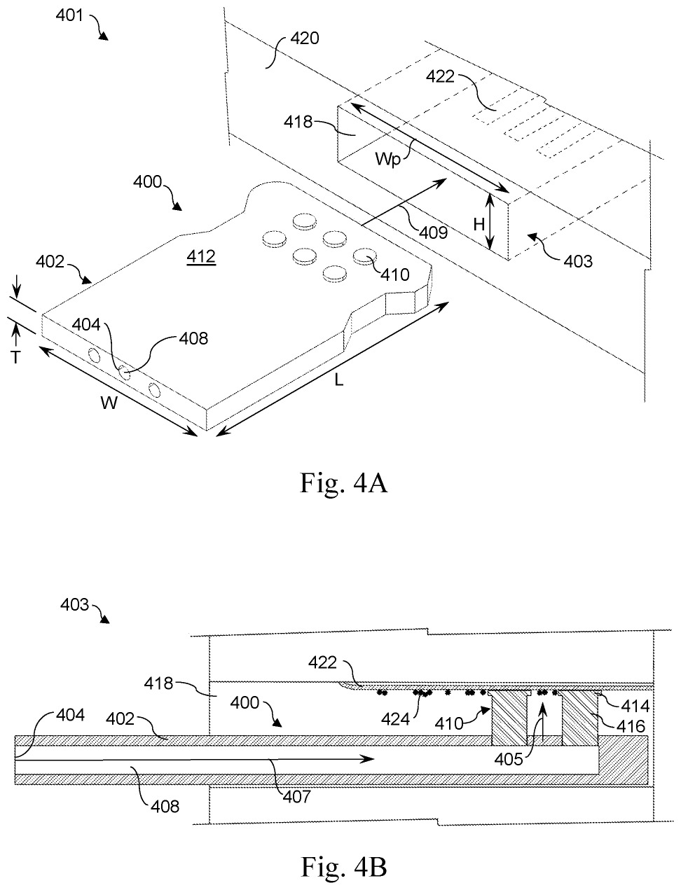

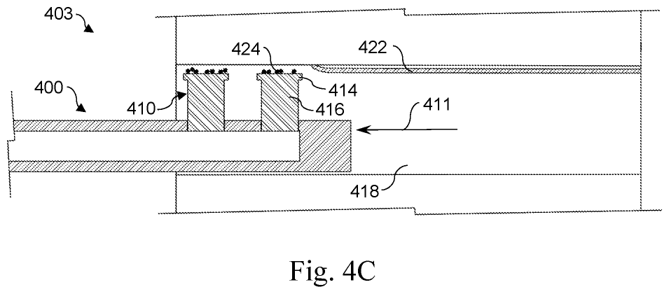

The body 102 may be a rigid or semi-rigid member or plate. In some implementations, the body 102 may be sized sufficiently or suitably to be inserted into a communication port of an electronic device. In other words, the body 102 may include a width and thickness substantially matching that, or smaller than, a width and height of a communication port with which the port cleaner 100 may engaged or inserted. Further, the body 102 may have a length suitable to enable the port cleaner 100 to be inserted into the communication port with a portion of the body 102 remaining extended out of the port once fully inserted such that a user or another device may grab onto the body to withdraw or extract the port cleaner 100 out of the communication port. In other implementations, the body 102 may have a length matching that of the communication port, and/or may additionally include another feature or component, such as a pull tab, extending from the body 102 out of the communication port to enable the port cleaner 100 to be extracted. The body 102, in some implementations, may have a substantially rectangular or cuboid structure, including a front surface 106, side surfaces, and a top surface 112. In other implementations, the body 102 may have a different structure or geometry, for example, geometries discussed below with regard to FIG. 4A.

The fluid channel 108 may be a hole, bore, cavity, or another type of channel disposed within the body 102. In some implementations, the fluid channel 108 may have a round structure or bore, as illustrated in FIGS. 1A-1B. The fluid channel 108 may extend in a straight line through the body 102, as illustrated. In other implementations, the fluid channel 108 may have or follow a different path through the body 102, e.g., a curved, bent, zig-zag, or other type of path. The fluid cavity 108 may follow any path that may connect the fluid aperture 104 with the contact wiper 110, or a wiper bore within which the contact wiper 110 maybe seated or disposed when in the lowered position.

The fluid aperture 104 may be an opening in the body 102 and may be fluidically coupled to the fluid channel 108. In some implementations, the fluid channel 108 may extend through a surface of the body 102 so as to define the fluid aperture 104. As such, the fluid aperture 104 may have a shape or geometry substantially matching a cross-section of the fluid channel 108. In the illustrated example, the fluid aperture 104 may be a round opening. In other implementations, the fluid aperture 104 may have a shape or structure that is dissimilar to the fluid channel 108. In some implementations, the fluid aperture 104 may be disposed on or extend into a side surface of the body 102, and, in further implementations, may extend into the front surface 106 of the body 102. In yet other implementations, the fluid aperture 104 may be disposed on any surface of the body 102 that may enable the fluid aperture 104 to be in fluid communication with the fluid channel 108.

Referring additionally to FIG. 1B, a perspective view of the example port cleaner 100 is illustrated wherein the contact wiper 110 is disposed in the raised position. As stated above, in some implementations, the contact wiper 110 may be seated or disposed within a wiper bore 110b when disposed in the lowered position. Further, the contact wiper 110 may extend or be raised or otherwise moved (for example, along direction 105) out of its seated position within the wiper bore 110b when moved from the lowered position to the raised position, as illustrated in FIG. 1B. The contact wiper 110 may be a rigid or semi-rigid component or post. In some implementations, the contact wiper 110 may be a substantially round or cylindrical post, and, in other implementations, the contact wiper 110 may have a different structure, e.g., a rectangular or cuboid structure.

The wiper bore 110b may be in fluid communication with the fluid channel 108. As such, fluid flowing along the fluid channel 108 may flow into, or increase the fluid pressure within, the wiper bore 110b. In one example, the contact wiper 110 may be actuated by fluid flowing from the fluid channel 108 to the wiper bore 110b. In this context, fluid may refer to air or compressed air, liquid, vapor, or any other fluid suitable for use in the port cleaner 100. In some situations, the fluid may be provided by a user or a device blowing into the fluid channel 108 through the fluid aperture 104. In another implementation, the fluid may be provided by a canister of compressed air, e.g., carbon dioxide or nitrogen, or by another method. The fluid may enter the fluid channel 108 from the fluid aperture 104, and travel along the fluid channel 108, for example, along direction 107, to the contact wiper 110 or the wiper bore 110b. The fluid may flow along the fluid channel 108 and follow any path that the fluid channel 108 may comprise. The fluid flowing within the fluid channel 108 may result in an increase of fluid pressure within the fluid channel 108 and/or the wiper bore 110b. Such an increase in fluid pressure may cause the contact wiper 110 to be actuated, i.e., to move or extend from the lowered position to the raised position. In some implementations, the contact wiper 110 may extend from the top surface 112 of the body 102 upon being actuated. It should be noted that the port cleaner 100, or the body 102 and/or the contact wiper 110 thereof, may have additional features such as ribs, tracks, ledges, shoulders, or other suitable features to support the above function and to prevent the contact wiper 110 from being completely removed from the body 102 upon being actuated.

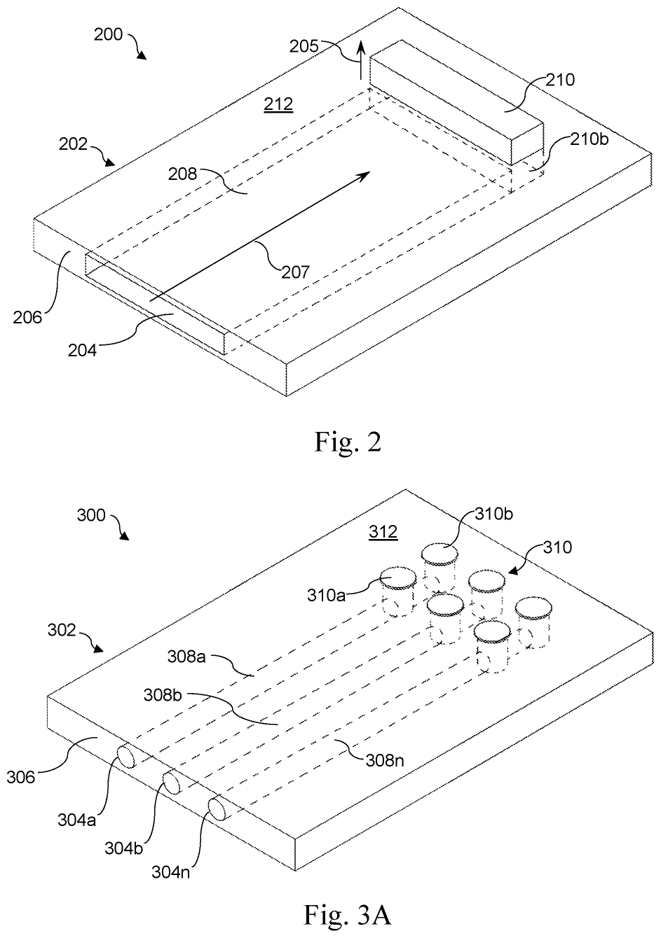

Referring now to FIG. 2, a perspective view of another example port cleaner 200 is illustrated. Example port cleaner 200 may be similar to example port cleaner 100, described above. Further, the similarly-named elements of example port cleaner 200 may be similar in function and/or structure to the respective elements of example port cleaner 100, as they are described above. Port cleaner 200 may include a body 202 having a front surface 206 and a top surface 212, a fluid channel 208 in fluid communication with a fluid aperture 204 extending into the front surface 206, and a contact wiper 210. The contact wiper 210 may be seated or positioned in a wiper bore 210b when disposed in a lowered position, and may extend or move out of the wiper bore 210b when moved to a raised position, extending from the top surface 212, as illustrated in FIG. 2. In order to actuate the contact wiper 210, or move the contact wiper 210 from the lowered position to the raised position, fluid may be blown or sent along the fluid channel 208, along example direction 207, from the fluid aperture 204 to the contact wiper 210 and push or raise the contact wiper 210 out of the wiper bore 210b, at least partially, such that the contact wiper 210 extends from the top surface 212 in the raised position. In the illustrated example, the contact wiper 210 may have a rectangular or cuboid structure, and the wiper bore 210b may have a corresponding shape or structure to receive the contact wiper 210. Further, the fluid channel 208 and the fluid aperture 204 may also have a rectangular structure that corresponds to the cuboid structure of the contact wiper 210. In other implementations, the fluid channel 208 and/or the fluid aperture 204 may have another shape or structure, e.g., a round structure, which may be dissimilar from the shape of the contact wiper 210 and the wiper bore 210b. The contact wiper 210 may have a structure so as to align and extend across a width of a signal transfer element such as an electrical contact or multiple signal transfer elements disposed within a communication port that is to receive the port cleaner 200. It should be noted that the contact wiper 210 may have another shape or structure suited to enable the contact wiper 210 to align with and contact signal transfer elements of a communication port.

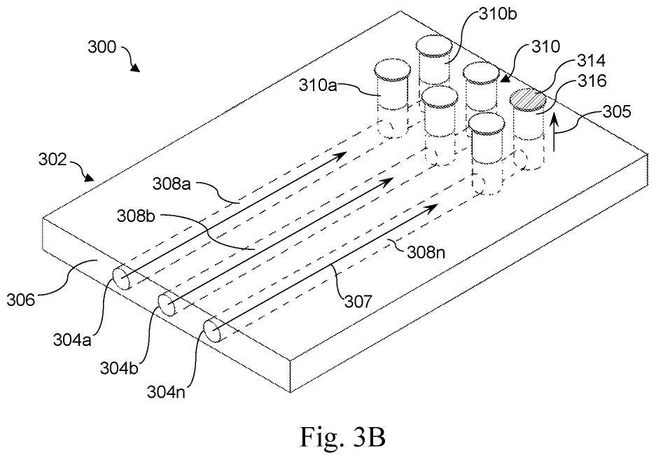

Referring now to FIG. 3A, a perspective view of another example port cleaner 300 is illustrated. Example port cleaner 300 may be similar to other example port cleaners described above. Further, the similarly-named elements of example port cleaner 300 may be similar in function and/or structure to the respective elements of other example port cleaners, as they are described above. In some implementations, the port cleaner 300 may include a body 302. Example port cleaner 300 may also include a plurality of fluid apertures 304a, 304b . . . 304n (referred to collectively as fluid apertures 304) disposed on a front surface 306 of the body 302, or disposed on another surface of the body 302. The plurality of fluid apertures 304 may be in fluid communication with a respective plurality of fluid channels 308a, 308b . . . 308n (referred to collectively as fluid channels 308) extending into the body 302. Although illustrated as having three fluid apertures in fluid communication with three fluid channels, it is contemplated that the example port cleaner 300 may have a differing number of fluid apertures and fluid channels. The example port cleaner 300 may further include a plurality of contact wipers (illustrated collectively as contact wipers 310). The contact wipers 310 may be movable between a lowered position, illustrated in FIG. 3A, and a raised position, illustrated in FIG. 3B. Each contact wiper of the plurality of contact wipers 310 may be operably engaged with one of the fluid channels of the plurality of fluid channels 308. In this context, operably engaged may refer to an engagement between a contact wiper and a respective fluid channel wherein an increase in fluid pressure within the respective fluid channel may transition or move the contact wiper from the lowered position to the raised position.

Referring additionally to FIG. 3B, a perspective view of the example port cleaner 300 is illustrated wherein the plurality of contact wipers 310 have been actuated and transitioned from the lowered position to the raised position, for example, along direction 305. The plurality of contact wipers 310 have been actuated by fluid flowing within or disposed within the plurality of fluid channels 308, for example along direction 307, which has resulted in an increase of fluid pressure behind each contact wiper of the plurality of contact wipers 310. In some implementations, each fluid channel of the plurality of fluid channels 308 is operably engaged with more than one contact wiper of the plurality of contact wipers 310. For example, fluid channel 308a is operably engaged with both contact wiper 310a and 310b, such that an increase in fluid pressure in fluid channel 308a behind contact wipers 310a and 310b causes contact wipers 310a and 310b to be actuated. It should be noted that, although the plurality of contact wipers 310 in the illustrated example are arranged in an array with two contact wipers operably engaged with a single fluid channel in a 3×2 arrangement, other layouts and arrangements are contemplated. For example, the plurality of contact wipers 310 may be arranged in a suitable manner such that they are aligned with a layout of signal transfer elements, e.g., electrical contacts, within a communication port with which the port cleaner 300 is designed to engage. In the illustrated example, the plurality of contact wipers 310 may be arranged in three sets of two to align with an array of three electrical contacts or other signal transfer elements within a communication port, wherein the two contact wipers of each set are to align with a single electrical contact or signal transfer element. Therefore, the plurality of contact wipers 310 may be arranged in any suitable manner to specifically align with the signal transfer elements of the communication port for which the port cleaner is designed. Further, the body of the port cleaner may also be specifically designed and structured for safe insertion into the communication port for which the port cleaner is designed.

In some implementations, each contact wiper of the plurality of contact wipers 310 may include a base portion 316 and a cleaning portion 314 disposed on top of the base portion 316. Each contact wiper of the plurality of contact wipers 310 may be a round or cylindrical post, in some implementations, with each base portion 316 and each cleaning portion 314 having a corresponding rounded structure. In other implementations, the plurality of contact wipers 310, and the associated base portions and cleaning portions, may have a differing structure than as illustrated. In some implementations, each base portion 316 may be structured to support the respective cleaning portion 314, and may also support the movement of the respective contact wiper from the lowered position to the raised position, and vice versa. Each cleaning portion 314, in some implementations, may include a cleaning surface (shown in cross-hatching) which may come into contact with an aligned signal transfer element of the communication port with which the port cleaner 300 is to be engaged. As such, each cleaning portion 314 may include a cleaning material. Cleaning materials may include soft materials such as cloth, felt, or other suitable soft materials. In further implementations, cleaning materials may include an abrasive material such as steel wool, sand paper, Scotch-Brite material, or other abrasive materials suitable for the cleaning and/or removal of corrosion or other contaminants.

Referring now to FIG. 4A, a perspective view of an example communication port 403 of an electronic device 401 is illustrated. The communication port 403 may include an inner cavity 418, an electrical contact 422 or other signal transfer element (hereinafter generally referred to as an electrical contact 422) disposed within the inner cavity 418, and a port cleaner 400. Example port cleaner 400 may be similar to other example port cleaners described above. Further, the similarly-named elements of example port cleaner 400 may be similar in function and/or structure to the respective elements of other example port cleaners, as they are described above.

The electronic device 401 may be a computing device, in some implementations. In further implementations, the electronic device 401 may be a notebook computer, a tablet computer, a desktop computer tower or display, an all-in-one computing device, a smartphone, or another type of computing device. In other implementations, the electronic device may be a device charger, a connector cable, or any other device having a communication port for the transfer of data, power, optical, or other signals. Correspondingly, the communication port 403 may be a Universal Serial Bus (USB) port (e.g., type A, type B, type C, Micro USB, Mini USB, or other USB port types), a memory card slot (e.g., a Secure Digital (SD), Micro SD, Mini SD memory card slot), a FireWire port, a Subscriber Identity Module (SIM) card slot, a High Definition Multimedia Interface (HDMI) port or another display port, a Serial Advanced Technology Attachment (SATA) or External SATA (eSATA) port, an Ethernet port, a Thunderbolt port, a headphone jack, or any other type of communication port having a signal transfer element for the transfer of data and/or power, or other signals. In other implementations, the communication port 403 may be an optical communication port, and the electrical contact 422 may be an optical connector component. In further implementations, the communication port 403 may have a plurality of electrical contacts 422 disposed within the inner cavity 418.

The electrical contacts 422 may be arranged in an array or layout within the communication port 403 specific to the type of communication protocol or technology utilized by the communication port 403, or for which the communication port 403 is designed. Similarly, the communication port 403 may have a physical structure, i.e., a width Wp and a height H, specific to the type of communication port. Accordingly, the port cleaner 400 may be specifically structured for use in a certain type of communication port 403. For example, the port cleaner 400 may have a body 402 with a width W, a thickness T, and a length L suitable to insert into the inner cavity 418 of the communication port 403. In other words, the body 402 may be sufficiently sized and structured to insert into or for use in a specific communication port 403. In some implementations, the body 402 may have a size and shape suitable to insert safely (i.e., without causing damage) into a USB port, a SIM card slot or port, a SD memory card slot, or another type of specific port.

The port cleaner 400 may include a contact wiper or a plurality of contact wipers 410 disposed on or in the body 402, which may be arranged to align with electrical connectors 422 of the specific type of communication port with which the port cleaner 400 will be used when the port cleaner 400 is inserted into the communication port 403. In other implementations, the contact wiper or plurality of contact wipers 410 may have an arrangement that could be used to align with multiple different electrical connector layouts. In other words, the plurality of contact wipers 410 may be capable of engaging with the electrical connectors 422 of multiple types of communication ports. In such an implementation, the body 402 of the port cleaner 400 may also be sized and structured so as to be able to safely insert into a variety of communication port types.

The port cleaner 400 may also have a fluid channel or a plurality of fluid channels 408 extending into the body 402 from a fluid aperture 404 and operably engaged with the contact wiper or plurality of contact wipers 410. The contact wiper or plurality of contact wipers 410 may be movable from a lowered position within the body 402 to a raised position, as described above. In some implementations, the contact wiper or plurality of contact wipers 410 may each have a cleaning portion 414 and a base portion 416, with the cleaning portion 414 being disposed on top of the base portion 416.

Referring additionally to FIG. 4B, a cross-sectional view of the example port cleaner 400 is illustrated, wherein the port cleaner 400 has been inserted into, or is disposed within the inner cavity 418 of the communication port 403. The cross-sectional view of FIG. 4B illustrates a singular fluid aperture 404, fluid channel 408, and two example contact wipers 410. Further, FIG. 4B also illustrates a single electrical contact 422 having corrosion or other contaminants 424 that have built up on or otherwise attached to the electrical contact 422. The port cleaner 400 may have been inserted into the inner cavity 418 while the contact wiper or the plurality of contact wipers 410 (hereinafter referred to as a singular contact wiper 410 for clarity) were disposed in the lowered position. As such, the port cleaner 400 has been inserted in a safe manner into the inner cavity 418, thereby avoiding the possibility of damaging any components disposed within the communication port 403. Upon being disposed within the inner cavity 418, a user or a device may have provided fluid, for example air, into the fluid channel 408 through the fluid aperture 404 along example direction 407. The fluid provided to the fluid channel 408 has caused an increase in fluid pressure within the fluid channel and behind the contact wiper 410 so as to actuate the contact wiper 410 and dispose the contact wiper 410 in the raised position along example direction 405, as illustrated. Upon being disposed in the raised position, the contact wiper 410, and/or the cleaning portion 414 thereof, has pressed against the electrical contact 422 with which the contact wiper 410 is aligned.

Referring now to FIG. 4C, a perspective view of the example communication port 403 is illustrated wherein the port cleaner 400 has been partially withdrawn, extracted, or otherwise removed from the inner cavity 418, or is in the process of fully withdrawing from the inner cavity 418, for example, along direction 411. As the port cleaner 400 is withdrawn from the inner cavity 418 of the communication port 403, the contact wiper 410, or the cleaning portion 414 thereof, is to slide, scrape, or wipe along the electrical contact 422. Such wiping or scraping action of the contact wiper 410 is to clean and/or remove any corrosion or other contaminants 424 from the electrical contact 422. As such, examples of port cleaners disclosed herein may be inserted safely into a communication port, whereupon a contact wiper or plurality of contact wipers may be actuated against an electrical contact or other signal transfer element within the communication port and wiped along the signal transfer element to remove contaminants thereon, thereby improving the function of the communication port in transferring data and/or power signals, or avoiding the inhibition of such function.

What is claimed is:

1. A port cleaner, comprising:
a body having a fluid aperture extending into a surface of the body;
a fluid channel disposed within the body and in fluid communication with the fluid aperture; and
a contact wiper operably engaged with the fluid channel and movable between a lowered position and a raised position, the contact wiper to extend from a top surface of the body when disposed in the raised position.

2. The port cleaner of claim 1, wherein fluid pressure within the fluid channel is to extend the contact wiper from the lowered position to the raised position.

3. The port cleaner of claim 2, wherein the body comprises a width and thickness suitable to insert into a communication port of an electronic device.

4. The port cleaner of claim 3, wherein the contact wiper is disposed on the body so as to align with an electrical contact of the communication port when the port cleaner is inserted into the communication port.

5. The port cleaner of claim 3, wherein the body comprises a size and shape suitable to insert into a Universal Serial Bus (USB) port of an electronic device.

6. The port cleaner of claim 3, wherein the body comprises a size and shape suitable to insert into a Subscriber Identity Module (SIM) card port of an electronic device.

7. The port cleaner of claim 3, wherein the body comprises a size and shape suitable to insert into a Secure Digital (SD) memory card port of an electronic device.

8. A port cleaner, comprising:
a body having a width and thickness smaller than a communication port of an electronic device;
a plurality of fluid apertures disposed on a front surface of the body and in fluid communication with a respective plurality of fluid channels extending into the body; and
a plurality of contact wipers movable between a lowered position, disposed within the body, and a raised position, extending from a top surface of the body, each contact wiper of the plurality of contact wipers operably engaged with one of the fluid channels of the plurality of fluid channels and to move to the raised position upon an increase in fluid pressure within the respective fluid channel.

9. The port cleaner of claim 8, wherein each fluid channel of the plurality of fluid channels is operably engaged with more than one contact wiper of the plurality of contact wipers.

10. The port cleaner of claim 8, wherein each contact wiper of the plurality of contact wipers includes a cleaning portion comprising a cleaning material.

11. The port cleaner of claim 8, wherein each contact wiper of the plurality of contact wipers is a round post.

12. The port cleaner of claim 8, wherein each fluid channel of the plurality of fluid channels has a round bore.

13. A communication port of an electronic device, comprising:
an inner cavity;
an electrical contact disposed within the inner cavity; and
a port cleaner disposed within the inner cavity, comprising:
a body having a width and thickness suitable to insert into the inner cavity;
a fluid channel extending into the body from a fluid aperture on a front surface of the body; and
a contact wiper having a cleaning portion and operably engaged with the fluid channel, the contact wiper movable from a lowered position within the body, to a raised position extending from a top surface of the body upon an increase in fluid pressure within the fluid channel.

14. The communication port of claim 13, wherein the cleaning portion of the contact wiper is to press against the electrical contact when disposed in the raised position.

15. The communication port of claim 14, wherein the cleaning portion of the contact wiper is to wipe along the electrical contact when the contact wiper is disposed in the raised position and the port cleaner is withdrawn from the inner cavity.
